(19) United States
(12) Patent Application Publication
(10) Pub. No.: US 2012/0089365 A1
(43) Pub. Date: Apr. 12, 2012

(54) DATA INTERPOLATION METHODS FOR METROLOGY OF SURFACES, FILMS AND UNDERRESOLVED STRUCTURES

(75) Inventors: Martin Fay, Middletown, CT (US); Jan Liesener, Middletown, CT (US); Peter de Groot, Middletown, CT (US); Xavier Colonna de Lega, Middlefield, CT (US)

(73) Assignee: Zygo Corporation, Middlefield, CT (US)

(21) Appl. No.: 13/267,408

(22) Filed: Oct. 6, 2011

Related U.S. Application Data
(60) Provisional application No. 61/391,315, filed on Oct. 8, 2010.

(51) Int. Cl. G01B 11/24; G01B 11/06; G06F 17/10; G06F 19/00

(52) U.S. Cl. 702/167; 702/189; 702/172; 703/2

(57) ABSTRACT

A method includes fitting a function to a subset of reflectivity data comprising values for the reflectivity of a test object for different wavelengths, different scattering angles, and/or different polarization states; determining values for the function at certain wavelengths and scattering angles and/or polarization states; and determining information about the test object based on the determined values.

### CROSS-REFERENCE TO RELATED APPLICATIONS

This application claims priority to Provisional Patent Application No. 61/391,315, entitled “DATA INTERPOLATION METHODS FOR METROLOGY OF SURFACES, FILMS AND UNDERRESOLVED STRUCTURES,” filed Oct. 8, 2010, the entire contents of which are incorporated herein by reference.

### BACKGROUND

The invention relates to optical metrology of surfaces, films, and unresolved structures.

Interferometric techniques are commonly used to measure the profile of a surface of an object. To do so, an interferometer combines a measurement wavefront reflected from the surface of interest with a reference wavefront reflected from a reference surface to produce an interferogram. Fringes in the interferogram are indicative of spatial variations between the surface of interest and the reference surface.

A scanning interferometer scans the optical path length difference (OPD) between the reference and measurement legs of the interferometer over a range comparable to, or larger than, the coherence length of the interfering wavefronts, to produce a scanning interferometry signal for each camera pixel used to measure the interferogram. A limited coherence length can be produced, for example, by using a white-light source, which is referred to as scanning white light interferometry (SWLI). A typical scanning white light interferometry (SWLI) signal is a few fringes localized near the zero optical path difference (OPD) position. The signal is typically characterized by a sinusoidal carrier modulation (the “fringes”) with bell-shaped fringe-contrast envelope. The conventional idea underlying SWLI metrology is to make use of the localization of the fringes to measure surface profiles.

SWLI processing techniques include two principle trends. The first approach is to locate the peak or center of the envelope, assuming that this position corresponds to the zero optical path difference (OPD) of a two-beam interferometer for which one beam reflects from the object surface. The second approach is to transform the signal into the frequency domain and calculate the rate of change of phase with wavelength, assuming that an essentially linear slope is directly proportional to object position. See, for example, U.S. Pat. No. 5,398,113 to Peter de Groot. This latter approach is referred to as Frequency Domain Analysis (FDA).

Scanning interferometry can be used to measure surface topography and/or other characteristics of objects having complex surface structures, such as thin film(s), discrete structures of dissimilar materials, or discrete structures that are underresolved by the optical resolution of an interference microscope. By “underresolved” it is meant that the individual features of the object are not fully separated in a surface profile image taken using the interference microscope as a consequence of the limited lateral resolution of the instrument. Surface topography measurements are relevant to the characterization of flat panel display components, semiconductor wafer metrology, and in-situ thin film and dissimilar materials analysis. See, e.g., U.S. Patent Publication No. US-2004-0189999-A1 by Peter de Groot et al. entitled “Profiling Complex Surface Structures Using Scanning Interferometry” and published on Sep. 30, 2004, the contents of which are incorporated herein by reference, and U.S. Patent Publication No. US-2004-0085544-A1 by Peter de Groot entitled “Interferometry Method for Ellipsometry, Reflectometry, and Scatterometry Measurements, Including Characterization of Thin Film Structures” and published on May 6, 2004, the contents of which are incorporated herein by reference.

Other techniques for optically determining information about an object include ellipsometry and reflectometry. Ellipsometry determines complex reflectivity of a surface when illuminated at an oblique angle, e.g., 60°, sometimes with a variable angle or with multiple wavelengths. To achieve greater resolution than is readily achievable in a conventional ellipsometer, microellipsometers measure phase and/or intensity distributions in the back focal plane of the objective, also known as the pupil plane, where the various illumination angles are mapped into field positions. Such devices are modernizations of traditional polarization microscopes or “conoscopes,” linked historically to crystallography and mineralogy, which employs crossed polarizers and a Bertrand lens to analyze the pupil plane in the presence of birefringent materials.

Conventional techniques used for thin film characterization (e.g., ellipsometry and reflectometry) rely on the fact that the complex reflectivity of an unknown optical interface depends both on its intrinsic characteristics (material properties and thickness of individual layers) and on three properties of the light that is used for measuring the reflectivity: wavelength, angle of incidence, and polarization state. In practice, characterization instruments record reflectivity fluctuations resulting from varying these parameters over known ranges. Optimization procedures such as least-squares fits are then used to get estimates for the unknown parameters by minimizing the difference between measured reflectivity data and a reflectivity function derived from a model of the optical structure.

Interferometers having multiple modes for determining characteristics of an object are disclosed in US 2006-0158657 A1 (now U.S. Pat. No. 7,428,057) and US 2006-0158658 A1, the entire contents both of which are incorporated herein by reference.

### SUMMARY

The disclosure features algorithms that can reduce noise in optical data (e.g., complex reflectivity data) associated with optical metrology of test objects (e.g., integrated circuit components). In certain embodiments, the noise-reducing algorithms (1) locally model and (2) interpolate the measured test object reflectivity within a subset of wavelengths, polarization states and/or scattering angles. For example, algorithms can fit a multi-dimensional surface through multiple experimental data points. In some embodiments, the dimensions correspond to wavelength, polarization state, and azimuthal and polar angles of light scattered from a test object. The algorithms then generate a smaller set of interpolated data points (i.e., fewer data points than the original reflectivity data) derived from the fitted surface. The result is a reduction in the number of samples to be further analyzed as well as a reduction of their uncorrelated noise content compared to the original data.

Alternatively, or additionally model reflectivity data, rather than measured data, can be fitted and the fitted surfaces are compared to measured data, e.g., over a wide range of wavelengths, polarization states and angles of incidence.

Generally, reflectivity data can be measured for a test object in a variety of ways. For example, ellipsometry, reflectometry, and/or interferometry methods, such as those mentioned above, can be used.

A variety of different test objects can be studied using the disclosed techniques. For example, test objects featuring complex surface structure can be studied. Examples of complex surface structure include: simple thin films (in which case, for example, the parameter(s) of interest may be the film thickness, the refractive index of the film, the refractive index of the substrate, or some combination thereof); multilayer thin films; sharp edges and surface features that diffract or otherwise generate complex interference effects; unresolved surface roughness; unresolved surface features, for example, a sub-wavelength width groove on an otherwise smooth surface; dissimilar materials (for example, the surface may include a combination of thin film and a solid metal, in which case a signal library may include both surface structure types and automatically identify the film or the solid metal by a match to the corresponding frequency-domain spectra); surface structure that give rise to optical activity such as fluorescence; spectroscopic properties of the surface, such as color and wavelength-dependent reflectivity; polarization-dependent properties of the surface; and deflections, vibrations or motions of the surface or deformable surface features that result in perturbations of the interference signal.

The methods and techniques described herein can be used for in-process metrology measurements of semiconductor chips. For example, scanning interferometry measurements can be used for non-contact surface topography measurements semiconductor wafers during chemical mechanical polishing (CMP) of a dielectric layer on the wafer. CMP is used to create a smooth surface for the dielectric layer, suitable for precision optical lithography. Based on the results of the interferometric topography methods, the process conditions for CMP (e.g., pad pressure, polishing slurry composition, etc.) can be adjusted to keep surface non-uniformities within acceptable limits.

Various aspects of the invention are summarized as follows.

In general, in a first aspect, the invention features a method, including fitting a function to a subset of reflectivity data comprising values for the reflectivity of a test object for different wavelengths, different scattering angles, and/or different polarization states; determining values for the function at certain wavelengths and scattering angles and/or polarization states; and determining information about the test object based on the determined values.

Implementations of the method can include one or more of the following features and/or features of other aspects.

The reflectivity data can be acquired experimentally. The reflectivity data can be acquired using an interferometry system. The interferometry system can acquire the reflectivity data by directing test light to the test object; subsequently combining the test light with reference light to form an interference pattern on a multi-element detector so that different regions of the detector correspond to different scattering angles of the test light by the test object, wherein the test and reference light are derived from a common source; monitoring the interference pattern using the multi-element detector while varying an optical path difference between the test light and the reference light; and determining the reflectivity data based on the monitored interference pattern.

Determining the information can include comparing the reflectivity data to data derived from a model of the test object.

The method can include selecting the subset of reflectivity data from acquired data prior to fitting the function. The subset can be selected based on a derivative of the acquired data with respect to the different wavelengths and/or different scattering angles. The subset can be selected where the data is well-behaved.

The function can define a multi-dimensional surface.

Noise in the determined values can be reduced relative to noise in the data corresponding to the reflectivity values.

The reflectivity data can include values for a real reflectivity and values for an imaginary reflectivity. Fitting the function can include fitting a first function to the real reflectivity values and fitting a second function to the imaginary reflectivity values. The first and second functions can be different.

Fitting the function comprises fitting different functions to different subsets of the data.

The method can include outputting the information about the test object.

The information about the test object can include information about a refractive index of a layer of the test object. The information about the test object can include information about a thickness of a layer of the test object. The information about the test object can include information about a structure on a surface of the test object.

In general, in another aspect, the invention features a method that includes directing test light to a test object; subsequently combining the test light with reference light to form an interference pattern on a multi-element detector so that different regions of the detector correspond to different scattering angles of the test light by the test object, wherein the test and reference light are derived from a common source; monitoring the interference pattern using the multi-element detector while varying an optical path difference between the test light and the reference light; determining the data based on the monitored interference pattern, the data corresponding to a characteristic of the test object as a function of scattering angles and wavelength and/or polarization states of the test light; fitting a function to a subset of the data; determining values for the function at certain wavelengths and scattering angles; and determining spatial information about the test object based on the determined values.

Implementations of the method can include one or more of the following features and/or features of other aspects. For example, the characteristic can be a complex reflectivity of the test object.

In general, in a further aspects, the invention features a system including an interferometer configured to direct test light to a test object and subsequently combine it with reference light, the test and reference light being derived from a common source; one or more optics configured to direct at least a portion of the combined light to a multi-element detector so that different regions of the detector correspond to different scattering angles of the test light by the test object, the detector being configured to produce interference signals based on the combined light; and an electronic processor in communication with the multi-element detector, wherein the electronic processor is arranged to determining reflectivity data including values for the reflectivity of the test object for different wavelengths, different scattering angles, and/or different polarization states from the interference signals, fit a function to a subset of the reflectivity data, determines values for the function at certain wavelengths and scattering angles, and determines information about the test object based on the determined values.

Embodiments of the system can include one or more of the following features and/or features or other aspects. For example, the interferometer can define a pupil and the one or more optics can be configured to image the pupil onto the multi-element detector.

The system can include a polarizer positioned in a path of the test light prior to an overlay test pad and an analyzer positioned in the path of the test light after the overlay test pad. The transmission axes of the polarizer and analyzer can be parallel or non-parallel (e.g., orthogonal).

The system can include a translation stage configured to adjust the relative optical path length between the test and reference light when they form the interference pattern. The system can include a base for supporting a test object, and wherein the translation stage is configured to move at least a portion of the interferometer relative to the base. The system can include the common source, wherein the translation stage is configured to vary the optical path length over a range larger than a coherence length for the common source.

The interferometer and one or more optics can be part of an interference microscope. The interference microscope can include a Mirau objective or a Linnik objective.

As used herein, “light” is not limited to electromagnetic radiation in the visible spectral region, but rather refers generally to electromagnetic radiation in any of the ultraviolet, visible, near infrared, and infrared spectral regions.

Unless otherwise defined, all technical and scientific terms used herein have the same meaning as commonly understood by one of ordinary skill in the art to which this invention belongs. In case of conflict with any document incorporated by reference, the present disclosure controls.

Other features and advantages will be apparent from the following detailed description.

### BRIEF DESCRIPTION OF THE DRAWINGS

FIG. 1 is a schematic diagram of an embodiment of an interferometry system.

FIG. 2A shows a plot of an interference signal measured by a given detector element of the detector in an interferometry system such as shown in FIG. 1.

FIG. 2B shows the result of Fourier transforming the interference signal shown in FIG. 2A to yield the spectral magnitude and phase as function of wavelength (or the corresponding wavenumber k).

FIG. 3A is a cross-sectional profile of a surface structure of a test object.

FIG. 3B is a cross-sectional profile of a surface structure of another test object.

FIGS. 4A and 4B are plots of the real and imaginary reflectivities as a function of azimuthal scattering angle for the surface structures shown in FIGS. 3A and 3B, respectively.

FIG. 5 is a flow chart showing steps in data analysis.

FIG. 6 is a plot showing the frequency content of the real component of the reflectivity data shown in FIG. 4A (black bars) and FIG. 4B (white bars).

FIG. 7 is a plot of the real and imaginary reflectivities as a function of azimuthal scattering angle for the surface structure shown in FIG. 3B, along with piece-wise approximation of the data in certain sections.

FIGS. 8A-8E show volumes in a three-dimensional data space in which rapid changes are not present. FIGS. 8A-8E correspond to wavelengths 450 nm, 500 nm, 550 nm, 600 nm, and 650 nm, respectively.

FIG. 9 shows a plot of real and imaginary components of a 280 nm pitch grating illuminated under a 50 degree angle of incidence with 450 nm light. The gray traces are experimental data and the black traces are modeled data.

FIGS. 10A-10C are plots comparing modeled data to measured data. The black vertical lines mark the differences between measured and modeling that are used to the drive the experiment.

FIG. 11 is a schematic diagram of an embodiment of an interferometry system.

FIGS. 12A and 12B are flow charts that describe steps for producing integrated circuits.

FIG. 13 is a schematic diagram of an embodiment of a LCD panel composed of several layers.

FIG. 14 is a flowchart showing various steps in LCD panel production.

Like reference numerals in different drawings refer to common elements.

### DETAILED DESCRIPTION

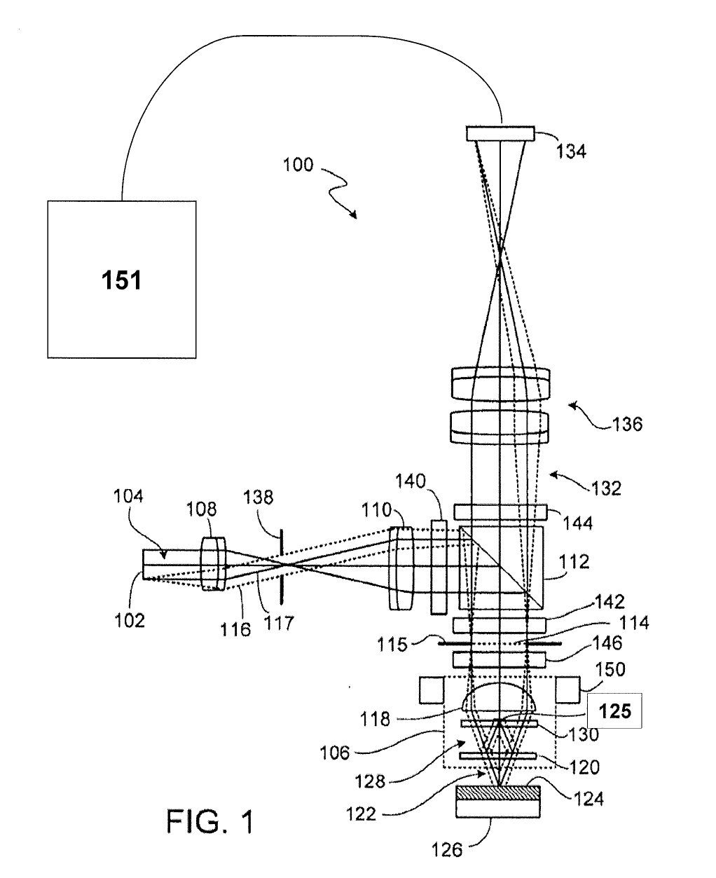

The complex reflectivity of a test object at multiple different wavelengths can be measured using an interferometry system. For example, FIG. 1 is a schematic diagram of an interferometry system 100, of the type described in US Patent Publication No. 2006-0158659-A1 “INTERFEROMETER FOR DETERMINING CHARACTERISTICS OF AN OBJECT SURFACE” by Xavier Colonna de Lega et. al., US Patent Publication No. 2006-0158658-A “INTERFEROMETER WITH MULTIPLE MODES OF OPERATION FOR DETERMINING CHARACTERISTICS OF AN OBJECT SURFACE”, by Xavier Colonna de Lega et. al., and US Patent Publication No. 2006-0158657 “A INTERFEROMETER FOR DETERMINING CHARACTERISTICS OF AN OBJECT SURFACE, INCLUDING PROCESSING AND CALIBRATION” by Xavier Colonna de Lega et. al., each of which is incorporated herein by reference.

Interferometry system 100 includes a source 102 (e.g., a spatially extended source) that directs input light 104 to an interference objective 106 via relay optics 108 and 110 and beam splitter 112. The relay optics 108 and 110 image input light 104 from spatially extended source 102 to an aperture stop 115 and corresponding pupil plane 114 of the interference objective 106 (as shown by the dotted marginal rays 116 and solid chief rays 117).

In the embodiment of FIG. 1, interference objective 106 is of the Mirau-type, including an objective lens 118, beam splitter 120, and reference surface 125. Beam splitter 120 separates input light 104 into test light 122, which is directed to a test surface 124 of a test object 126, and reference light 128, which reflects from reference surface 125. Objective lens 118 focuses the test and reference light to the test and reference surfaces, respectively. The reference optic 130 supporting reference surface 125 is coated to be reflective only for the focused reference light, so that the majority of the input light passes through the reference optic before being split by beam splitter 120.

After reflecting from the test and reference surfaces, the test and reference light are recombined by beam splitter 120 to form combined light 132, which is transmitted by beam splitter 112 and relay lens 136 to form an optical interference pattern on an electronic detector 134 (for example, a multi-element CCD or CMOS detector). The intensity profile of the optical interference pattern across the detector is measured by different elements of the detector and stored in an electronic processor (not shown) for analysis. Unlike a conventional profiling interferometer in which the test surface is imaged onto the detector, in the present embodiment, relay lens 136 (e.g., a Bertrand lens) images different points of the pupil plane 114 to corresponding points on detector 134 (again as illustrating by dotted marginal rays 116 and solid chief rays 117).

Because each source point illuminating pupil plane 114 creates a plane wave front for test light 122 illuminating test surface 124, the radial location of the source point in pupil plane 114 defines the angle of incidence of this illumination bundle with respect to the object normal. Thus, all source points located at a given distance from the optical axis correspond to a fixed angle of incidence, by which objective lens 118 focuses test light 122 to test surface 124. A field stop 138 positioned between relay optic 108 and 110 defines the area of test surface 124 illuminated by test light 122. After reflection from the test and reference surfaces, combined light 132 forms a secondary image of the source at pupil plane 114 of the objective lens. Because the combined light on the pupil plane is then re-imaged by relay lens 136 onto detector 134, the different elements of the detector 134 correspond to the different illumination angles of test light 122 on test surface 124.

In some embodiments, polarization elements 140, 142, 144, and 146 are optionally included to define the polarization state of the test and reference light being directed to the respective test and reference surfaces, and that of the combined light being directed to the detector. Depending on the embodiment, each polarization element can be a polarizer (e.g., a linear polarizer), a retardation plate (e.g., a half or quarter wave plate), or a similar optic that affects the polarization state of an incident beam. Furthermore, in some embodiments, one or more of the polarization elements can be absent. In some embodiment these elements are adjustable, for instance mounted on a rotation mount, and even motorized under electronic control of the system. Moreover, depending on the embodiment, beam splitter 112 can be polarizing beam splitter or a non-polarizing beam splitter. In general, because of the presence of polarization elements 140, 142 and/or 146, the state of polarization of test light 122 at test surface 124 can be a function of the azimuthal position of the light in pupil plane 114.

In the presently described embodiment, source 102 provides illumination over a broad band of wavelengths (e.g., an emission spectrum having a full-width, half-maximum of more than 50 nm, or preferably, even more than 100 nm). For example, source 102 can be a white light emitting diode (LED), a filament of a halogen bulb, an arc lamp such as a Xenon arc lamp or a so-called supercontinuum source that uses non-linear effects in optical materials to generate very broad source spectra (e.g., >200 nm). The broad band of wavelengths corresponds to a limited coherence length.

A translation stage 150 adjusts the relative optical path length between the test and reference light to produce an optical interference signal at each of the detector elements. For example, in the embodiment of the FIG. 1, translation stage 150 is a piezoelectric transducer coupled to interference objective 106 to adjust the distance between the test surface and the interference objective, and thereby vary the relative optical path length between the test and reference light at the detector. The optical interference signals are recorded at detector 134 and processed by a computer 151 that is in communication with the detector.

The interference signal measured at each detector element is analyzed by the computer, which is electronically coupled to both detector 134 and translation stage 150. During analysis, computer 151 (or other electronic processor) determines the wavelength-dependent, complex reflectivity of the test surface from the interference signal. For example, the interference signal at each detector element can be Fourier transformed to give the magnitude and phase of the signal with respect to wavelength. This magnitude and phase can then be related to conventional ellipsometry parameters.

In some embodiments, interferometry system 100 can include polarizing beam splitter (i.e., beamsplitter 112 is a polarizing beam splitter) and no further polarizers or wave plates. For example, beamsplitter 112 can include two regions having mutually orthogonal pass axes. Incoming light enters pupil plane 114 in one polarization state and has to undergo a polarization change in order not to be blocked by the polarizing beam splitter upon reflection from the test object. In some embodiments, two polarizers having differing orientations are positioned at or near pupil plane 114, each one being positioned in only part of the optical path in the interference microscope.

In some embodiments, similar optical asymmetry can be introduced by the interferometry system hardware where polarizer and analyzer are parallel to one another, for instance to characterize critical dimensions of a test structure. For example, this can be accomplished by introducing a set of polarizing elements between the polarizing beam splitter cube and the microscope objective. That set of polarizing elements may be, e.g., a quarter wave plate followed by a polarizer oriented at 0° or 90°, a half wave plate followed by a polarizer oriented at 0° or 90° or a polarizer oriented at 45° followed by a polarizer oriented at 0° or 90°. The insertion/removal of these two elements can be motorized to allow rapid switching from a cross-polarizer to a parallel-polarizer configuration. Such arrangements can enable a single instrument to perform both CD and overlay measurements, for example.

In some embodiments, a dissimilar polarizer-analyzer configuration is realized by using a non-polarizing beam splitter cube, placing a polarizer in the illumination leg in front of the beam splitter cube and an analyzer in the imaging leg after the beam splitter cube. Similar to the previous configuration, this configuration allows switching between a regular setup (i.e., parallel polarizer and analyzer) and a dissimilar polarizer-analyzer configuration where the polarizer/analyzer orientation is controlled (e.g., by means of mechanical rotary stages or active polarization elements such as an electrically controlled LCD).

For an idealized Mirau objective, the polarization state of the reference beam would not change on its path through the objective. Consequently, in such a system with a dissimilar polarizer-analyzer configuration, reference light is blocked by the polarizing beam splitter on the way to the camera preventing any interference signal. In practice, however, the reference light significantly changes its polarization state on its way through the objective (e.g., due to interaction with coated optics with optical power-beam splitter-reference mirror-beam splitter-coated optics with optical power). A portion of the reference light is therefore able to pass the polarizing beam splitter and is available for interference with the light coming from the test object. The polarization state of x or y polarized beams is not expected to change in the reference path if the azimuth angle of the polarization is equal to 0°, 90°, 180° or 270° and therefore those beams are blocked by the polarizing beam splitter. In some embodiments, homogeneity of the reference light across the pupil can be improved by including a polarization changing element in the reference path. For example, in some embodiments, a wave plate can be included in the reference path. Alternatively, or additionally, a structured reference mirror with grating lines oriented at 45° can be used.

While the interference microscope shown in FIG. 1 is a Mirau-type microscope, other types of microscope can also be used. For example, in some embodiments, a Linnik-type interference microscope can be used. In certain embodiments, a Linnik-type microscope can provide more flexibility for modulating polarization of the reference beam because the reference beam path is physically more accessible relative to a Mirau-type objective. A quarter-wave plate in the collimated space of the reference path, for example, can be provided to cause a rotation of the polarization in double-pass and therefore provide a completely illuminated pupil as seen by the camera. The use of a Linnik-type interference microscope can also allow adjusting the reference light intensity with respect to the test light intensity in order to maximize the fringe contrast. For example, a neutral density filter can be positioned in the path of the reference light to reduce its intensity as necessary.

Adjustment of the reference light intensity relative to the test light intensity can also be done with a polarized Mirau objective, e.g., in which the beam splitter is sandwiched between two quarter wave plates. In such configurations, the reference and test light have orthogonal polarization states. Placing an analyzer aligned with the reference light polarization (lighting the entire pupil) can cause the test light to experience a dissimilar polarizer/analyzer configuration.

### Measurement Model

To demonstrate the analysis of the interference signals obtained by interferometry system 100, we consider an embodiment in which polarization elements 140 and 144 are linear polarizers, polarization elements 142 and 146 are absent, and beam splitter 112 is a non-polarizing beam splitter. The effect of the linear polarizer 140 is to create an identical linear polarization state at every point in pupil plane 114. As a result, the polarization of the light incident on test surface 124 is linear, but its orientation with respect to the plane of incidence is a function of the azimuthal location of the source point at the pupil plane. For example, the source points that belong to a pupil diameter that is parallel to the direction of the linear polarization in the pupil plane will generate illumination light that is linearly polarized within the plane of incidence at the test surface (this is called the P polarization state). Similarly, the source points that belong to a diameter that is perpendicular to the direction of the linear polarization in the pupil plane will generate illumination light that is linearly polarized perpendicularly to the plane of incidence (this is called the S polarization state). Source points that do not belong to these two diameters will create illumination light on the test surface that has a mix of S and P polarization states. This is relevant because the reflectivity coefficients for the test surface are different for S and P polarized light.

The two linear polarizers can have a number of relative orientations that will dictate the content of the interference signal detected by the detector. For example, if the polarizers are parallel then the measured interference signal will depend solely on S-polarized test light being incident on the test surface for one diameter of the pupil plane and depend solely on P-polarized test light being incident on the test surface for an orthogonal diameter of the pupil plane (and similarly, for the reference light incident on the reference surface). This is attractive because the difference between the magnitude and phase of S and P reflectivities is the basis for ellipsometry. If desired, therefore, simplified processing of the data can be restricted to these two diameters. On the other hand, using the data over the entire pupil plane requires taking into account the mix of the two polarization states, but provides more data points and thus increases the resolution of the measurement.

The following analysis applies to the arrangement with the two linear polarizers aligned parallel to one another. In this case, the amount of test light that is transmitted through the second linear polarizer (polarization element 144) to detector 134 can be expressed as:

Eₒᵤₜ=½(cos(θ)²rp·tp−sin(θ)²rs·ts)Eᵢₙ (1)

where θ is the azimuth angle measured with respect to the direction of the polarizers, rp and rs are the complex reflection coefficients of the object surface for P and S polarization states (known as the “Fresnel reflection coefficients”), tp and ts are the transmission coefficients for P and S polarization states for the round trip through the interference objective 106 and the main beam splitter 112 and Eₒᵤₜ is the complex amplitude of the electric field. This model assumes that the optics are free from birefringence and that reflection off the object surface is also free from mechanisms that would mix the S and P polarizations states. For example, a uniaxial material with its axis along the local surface normal can be characterized in this context, however, a material having in-plane birefringence requires a different model.

In practice, the same model applies for the reference light that propagates along the reference leg of the interferometer, however, the reflection and transmission coefficients are a priori different:

Eₒᵤₜ^{r}=½(cos(θ)²rp^{r}·tp^{r}−sin(θ)²rs^{r}·ts^{r})Eᵢₙ (2)

The interference pattern that is measured at the detector for a given source wavelength λ and a given source point at the pupil plane consists of a modulating term that is proportional to the product EₒᵤₜEₒᵤₜ^{r}:

Intensity(k,α,z)=+|Eₒᵤₜ|²+|Eₒᵤₜ^{r}|²+2|Eₒᵤₜ∥Eₒᵤₜ^{r}|cos(2k cos(α)z+φ(k,α)) (3)

where k=2π/λ, λ is the wavelength of the light, z is the vertical location of the test surface during a mechanical scan relative to a zero optical path length difference between the test and reference light, α is the angle of incidence of the light at the test surface (which depends on the source point location at the pupil) and φ is a phase difference between the test and reference electric fields. In practice, the signal measured at a given detector location is the sum of all such signals generated by the various wavelengths present in the source spectrum. As a result, a Fourier transformation of the signal allows separating these contributions into complex spectral components corresponding to very narrow wavelength ranges. Note that in order to assign a calculated spectral component to a specific source wavelength one should take into account the correction factor cos(α), which shifts the location of these spectral components. This correction factor involves knowing the angle of incidence of light at each pixel of the detector. A calibration of the optical system can be used for this task. An example of such a calibration is described in U.S. Pat. No. 7,446,882, the entire content of which is incorporated herein by reference.

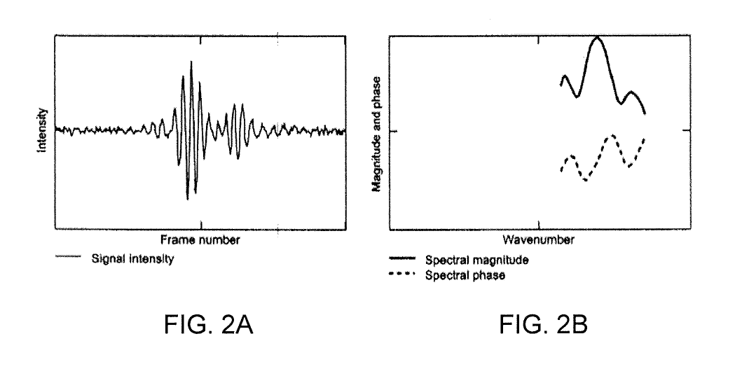

FIG. 2A shows a representative interference signal measured by a given detector element of detector 134 (corresponding to a given location in the pupil plane) when measuring a 1003-nm thick silicon dioxide film on silicon. FIG. 2B shows the result of Fourier transforming the interference signal to yield the spectral magnitude and phase as function of wavelength (or the corresponding wavenumber k). The variation in the spectral magnitude and phase is a result of the variation of the Fresnel reflection coefficient as a function of the wavelength (or wavenumber).

In certain embodiments, the frequency transform processing is applied to a region of interest within the image of the pupil plane on the detector. For example, the region of interest can be an annulus, which defines a given range of angles of incidence at the test surface. The azimuthal location of a pixel (i.e., one of the detector elements) within this annulus defines the mix of S and P polarization that illuminates the test surface and the radial distance of the pixel to the optical axis defines the angle of incidence. Furthermore, it can be useful to extract (possibly using interpolation) the spectral components as described above over multiple circles within the region of interest. These components calculated over one such circle can be written in the form:

$${Z}_{α λ θ} = {L}_{λ} {I}_{α λ θ} exp ( i {ϕ}_{αλ h} ) ( {cos ( θ )}^{2} {ρ}_{α λ} - {sin ( θ )}^{2} {τ}_{αλ} ) \\ with {ρ}_{αλ} = \frac{r {p}_{α λ}}{r {s}_{α λ}} and {τ}_{α λ} = \frac{t {s}_{α λ}}{t {p}_{α λ}} \qquad ( 4 )$$

where the subscripts denote a functional dependence, α is the angle of incidence corresponding to the radius of the circle at the pupil plane, λ is the wavelength of light, θ is the azimuthal angle measured with respect to the linear polarizers, h is a height offset of the object surface, L is a real scaling factor related to the source intensity or signal strength and I is a complex function that represents the variations of the light intensity across the source as well as phase and amplitude variations occurring in the optics.

The electronic processor can use the above formula as the key model for the measurement process. For example, the processor can Fourier transform the interference signals recorded by the detector to yield the component Z for different wavelengths and angles of incidence and by inversion extract the complex ratio rp/rs that relates to the test surface being characterized (e.g., based on Eq. 4). This ratio is called the ellipsometric ratio and can also be expressed as:

$${ρ}_{αλ} = \frac{r {p}_{α λ}}{r {s}_{α λ}} = tan ( {Ψ}_{α λ} ) exp ( i {Δ}_{α λ} ) \qquad ( 5 )$$

where Ψ and Δ are the two well-known ellipsometric parameters, from which optical properties (e.g., thickness and refractive index of transparent films) of the test object can be calculated.

For example, for the case of a homogeneous test surface devoid of films, the electronic processor can readily calculate the complex refractive index of the material according to the expression:

$$n ( λ ) = {n}_{0} tan ( α ) \sqrt{1 - \frac{4 {ρ}_{αλ}}{{( 1 + {ρ}_{αλ} )}^{2}} {sin ( α )}^{2}} \qquad ( 6 )$$

where n₀ is the refractive index of the ambient medium, usually air. The technique provides in this case the complex refractive index over the entire source spectrum. Data calculated over multiple angles of incidence can be averaged to improve the measurement resolution.

In another example, for the case of a transparent monolayer having an unknown thickness t and known refractive indices n₀, n₁, n₂ of the ambient, film and substrate materials, the electronic processor can determine the unknown thickness t according to the following equations:

$${α}_{0} = α , {α}_{1} = \frac{{n}_{0} ( λ )}{{n}_{1} ( λ )} sin ( {α}_{0} ) , {α}_{2} = \frac{{n}_{1} ( λ )}{{n}_{2} ( λ )} sin ( {α}_{1} ) \\ {r}_{01 p} = \frac{tan ( {α}_{0} - {α}_{1} )}{tan ( {α}_{0} + {α}_{1} )} , {r}_{12 p} = \frac{tan ( {α}_{1} - {α}_{2} )}{tan ( {α}_{1} + {α}_{2} )} \\ {r}_{01 s} = \frac{sin ( {α}_{0} - {α}_{1} )}{sin ( {α}_{0} + {α}_{1} )} , {r}_{12 s} = - \frac{sin ( {α}_{1} - {α}_{2} )}{sin ( {α}_{1} + {α}_{2} )} \\ A = {r}_{01 p} , B = {r}_{12 p} + {r}_{01 p} {r}_{01 s} {r}_{12 s} , C = {r}_{12 p} {r}_{01 s} {r}_{12 s} \\ D = {r}_{01 s} , E = {r}_{12 s} + {r}_{01 p} {r}_{01 s} {r}_{12 p} , F = {r}_{01 p} {r}_{12 p} {r}_{12 s} \\ X = \frac{- ( B - {ρ}_{α λ} E ) \pm \sqrt{\begin{matrix}{( B - {ρ}_{αλ} E )}^{2} - \\ 4 ( C - {ρ}_{αλ} F ) ( A - {ρ}_{αλ} D )\end{matrix}}}{2 ( C - {ρ}_{σλ} F )} \\ t = \frac{i λ}{4 π {n}_{1} ( λ ) cos ( {α}_{1} )} log ( X ) \qquad ( 7 )$$

where log is the complex natural logarithm function, i=\sqrt{−1} and the sign in the calculation of X is chosen according to the resulting value of t, which must be real positive. The processing of the data obtained by interferometry system 100 provides multiple estimates of t, because the measurement is performed for multiple values of α and λ. These multiple estimates can be used to solve for a possible ambiguity in the film thickness associated with the term X in Eq. 7 and to improve the measurement resolution. In other embodiments, the electronic processor can derive one or more of the refractive indices of the test object from the measurement data based on a similar set of equations.

For more general cases, the electronic processor can use, for example, the “scattering matrix” approach to calculate the reflection coefficients of an test surface as a function of its unknown parameters (refractive indices, film thicknesses, layer roughness, refractive index gradients, etc). The reflection coefficient functions are applied to calculate the ellipsometric parameters Ψ^{model} and Δ^{model} for guess values of the unknown parameters. An iterative algorithm is then used to vary these parameters in order to minimize the sum of the squared differences between the measured ellipsometric coefficients and corresponding model coefficients:

χ²=Σ(Ψ_{αλ}−Ψ_{αλ}^{model})²+Σ(Δ_{αλ}−Δ_{αλ}^{model})² (8)

Alternative merit functions can be defined that include for example weighting factors for the different wavelengths and angles of incidence. Such approaches are described, for example, in R. M. A. Azzam and N. M. Bashara, “Ellipsometry and Polarized Light,” Elsevier Science B. V., ISBN 0 444 87016 4 (paperbook), 1987.

Generally, the complex reflectivity of a test object that includes more than one reflective interface (e.g., a substrate having a thin film of a dielectric material) and/or underresolved features (e.g., pillars, trenches, or lines that form integrated circuits) varies in a complicated way with respect to wavelength, scattering angle, and polarization.

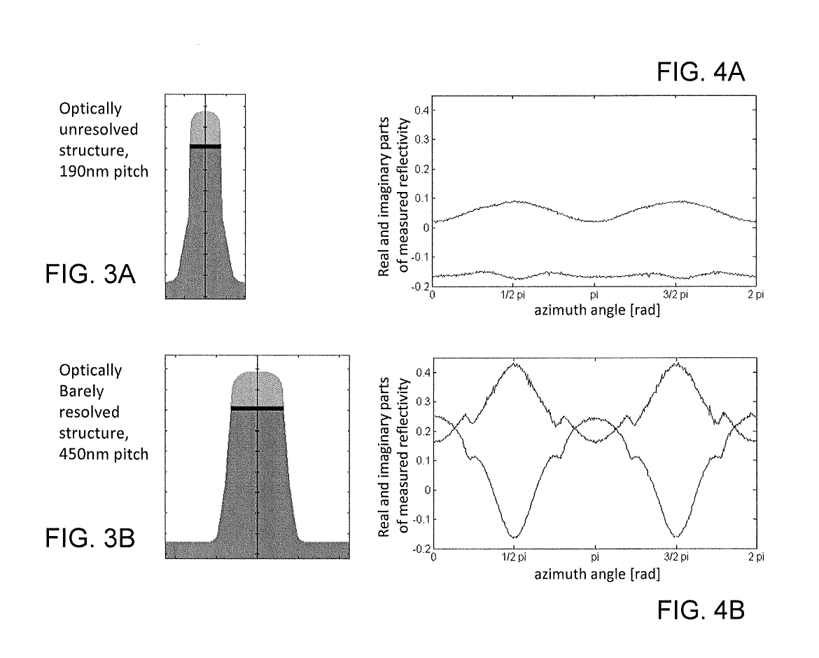

For example, referring to FIGS. 3A, 3B, 4A, and 4B, the reflectivity of an underresolved (FIG. 3A) and a barely resolved (FIG. 3B) structure are shown for the same angle of incidence and wavelength (FIGS. 4A and 4B, respectively). In this example, the structures shown in FIGS. 3A and 3B are shallow-trench isolation (“STI”) structures of different pitch in a process step where the structures consist of lithographically generated silicon nitride pads on top, separated from the silicon wafer by a thin oxide layer and with the exposed parts of the silicon etched to a certain depth. The structure shown in FIG. 3A had a pitch of 190 nm, while the structure shown in FIG. 3B had a pitch of 450 nm.

The data shown in FIGS. 4A and 4B was acquired using an interferometry system as shown in FIG. 1. The data was acquired for light linearly-polarized with respect to the orientation of the structures and is shown for a polar scattering angle of 40°.

For the larger structure (shown in FIG. 3B), the reflectivity function (shown in FIG. 4B) is significantly more featured (e.g., has more inflection points, steeper gradients) and thus computationally harder to approximate with an analytical fit function.

In general, analysis of the complex reflectivity data can be simplified by reducing the number of data points that need to be modeled. Such reductions can be performed by an interpolation process that is described below. Advantageously, such interpolation can also reduce noise in acquired reflectivity data by combining individual measurement values. Furthermore, while the following description relates specifically to complex reflectivity coefficients, the analysis can be applied to other forms of reflectivity data as well. For example, in some embodiments, the analysis can be applied to reflectance data (i.e., the magnitude of the complex reflectivity) or to data derived from the complex reflectivity.

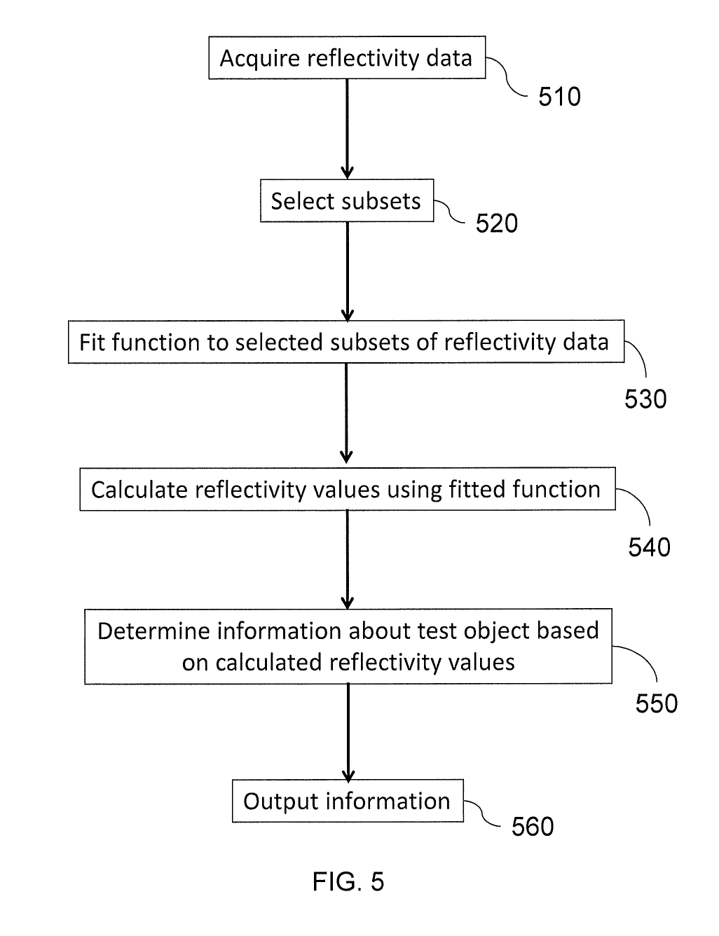

A flow chart outlining an interpolation process is shown in FIG. 5. Initially, reflectivity data (e.g., complex reflectivity data) is a acquired for a test object (step 510). In some embodiments, the reflectivity data is composed of a real and imaginary value for a range of wavelengths and scattering angles (e.g., an azimuthal scattering angle and a polar scattering angle) for different polarization states (e.g., P and S polarization states). Such data can be acquired using the interferometric methods and systems described above.

Next, one or more subsets of the data is selected for further analysis (step 520). Typically, the selected subsets correspond to portions of the data where the data is functionally well-behaved. This means that the selected portions of data correspond to smoothly varying or differentiable functions. For example, portions of data that vary linearly, quadratically, or according to some other low-order geometric function (e.g., 4^{th} order or less), would be considered functionally well-behaved portions of data. As an alternative, or in addition to looking at the differentiability of the data for different subsets, one can select subsets of the data based on the signal-to-noise ratio of the data. For example, subsets for further analysis can be selected in regions where the signal noise is low or the signal strength high.

Selection of data subsets can be performed empirically or determined in advance of acquiring the data. Empirical selection can involve, for example, direct inspection of acquired data, e.g., presently graphically, to identify subsets suitable for fitting. Alternatively, or additionally, one can analyze the data, e.g., by determining a local derivative of the data at different sections and selecting the subsets based on the value of the derivative. Selection in advance can be based on reflection models of the structure of the test object or based the expected reflectivity behavior of the test object established from prior measurements of the same or similar structures.

In general, any subset of the reflectivity data can be selected for interpolation analysis. For example, in some embodiments, portions of the real reflectivity data as a function of scattering angle (e.g., azimuthal and/or polar scattering angle), polarization state, and/or wavelength can be selected. Alternatively, or additionally, portions of the imaginary reflectivity data can be selected (as functions of the same or different parameters as the real reflectivity data). In some embodiments, real and imaginary reflectivity data portions as a function of azimuthal scattering angle can be selected, such as portions of the curves shown in FIGS. 4A and 4B.

In some embodiments, the experimental data are pre-analyzed to delimitate regions of the parameter space over which for example the first m derivatives (e.g., the first two derivatives, the first three derivatives, the first four derivatives) of the measured reflectivity do not exceed some set thresholds. These thresholds can be established empirically or analytically. In the analytical case, the desired sampling density of the data modeling and/or the contribution to those derivatives arising from signal noise can be taken into account.

Once the data subsets are selected, a function is fitted to the selected portions of the data (step 530). Generally, the fitting function varies depending upon the expected behavior for the data portion.

For example, if a linear behavior is expected with respect to all three variables (wavelength, polarization, and scattering angle) for a subset, then it is straightforward to simply average the data collected within some limited range to create a new measurement point centered within this range. This averaging can also reduce noise in the reflectivity data. For example, if a total of n individual measurement points are combined in this fashion the uncorrelated noise components associated with these data points average out and the noise associated with the new value is reduced by a factor \sqrt{n}. The result is a new data point with improved noise statistics.

In other examples, more complicated dependencies of the experimental data with respect to the three variables can be fit. For instance, least-squares algorithms can be applied to fit functions of various complexities to a selected range of experimental data points: approaches include fitting planes, quadratics or higher-order multivariate polynomials. Splines are one type of polynomial that can also be used for this application, especially fitting splines that are not forced through the raw data and provide controls for the stiffness of the fit. Special basis functions might bring a benefit in some cases: for example, Legendre polynomials are well suited for modeling surfaces that have independent radial and azimuthal dependencies. Other basis functions might require using iterative least-squares methods such as the Levenberg-Marquardt algorithm.

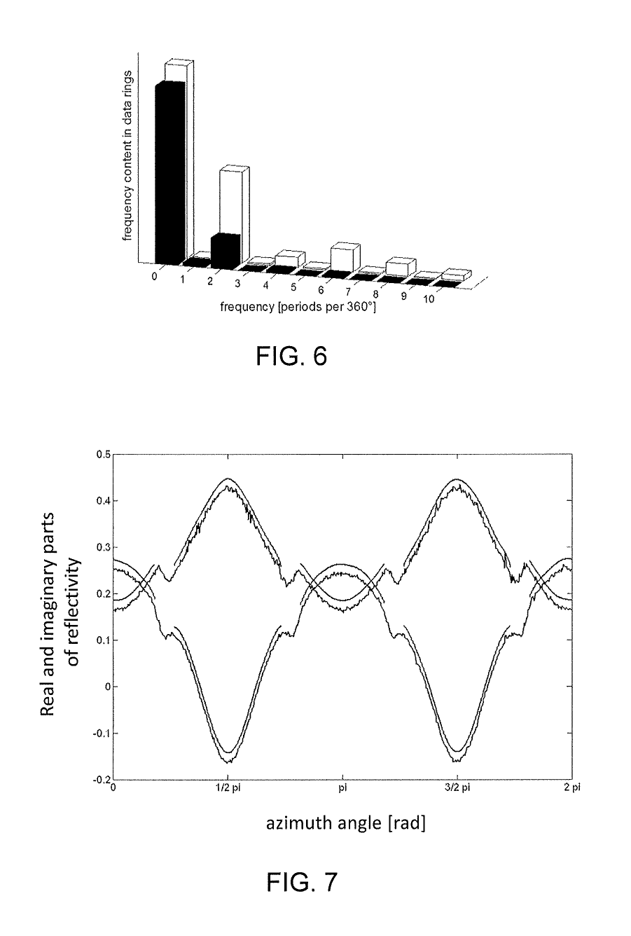

In some embodiments, fitting functions can be determined based on the frequency content of the reflectivity data. For example, in situations where contributions to the frequency content of the reflectivity data is dominated by only a few harmonics (e.g., two to four harmonics), a fitting function can be selected as a Fourier series where the only non-zero coefficients correspond to those harmonics. Referring to FIG. 6, by way of example, the frequency content of the reflectivity data corresponding to a single polar scattering angle for the optically underresolved structure (black bars in FIG. 6) and the optically resolved structure (white bars in FIG. 6) are shown. This data corresponds to the data plots shown in FIGS. 4A and 4B, respectively. The frequency content of the underresolved structure (black bars) includes contribution mostly from the zeroth and second order harmonics and some minor contributions at fourth and sixth order. Accordingly, one option would be to fit this signal with a Fourier series having only zeroth, second, fourth and sixth order terms. In contrast, the signal from the larger structure includes significant contributions at higher frequencies (white bars in FIG. 6). Thus, fitting a Fourier series to this data should include contributions from higher order harmonics.

Once parameters for a fitting function have been established, reflectivity values are calculated (FIG. 5, step 540). These reflectivity values can then be used to determine information about the test object in the same way one would determine information from the acquired data (FIG. 5, step 550). For discussions regarding how such information can be used to determine information about a test object, see, for example, U.S. Pat. No. 7,446,882 entitled “Interferometer for Determining Characteristics of an Object Surface,” issued on Nov. 4, 2008, U.S. Pat. No. 7,428,057 entitled “Interferometer for Determining Characteristics of an Object Surface,” issued on Sep. 23, 2008, U.S. 2008-0174784 entitled “Apparatus and Method for Measuring Characteristics of Surface Features,” filed on Dec. 21, 2007, U.S. Ser. No. 12/535,357 entitled “Interferometer for Determining Overlays,” filed on Aug. 4, 2009, and U.S. 2010-0128283 entitled “Interferometric Systems and Methods Featuring Spectral Analysis of Unevenly Sampled Data,” filed Jul. 24, 2009, the entire contents each of which are incorporated herein by reference. This information is then output to a person or machine user of the information (FIG. 5, step 560).

FIG. 7 shows a plot of sub-regions in one-dimensional space that lead to lower order fit functions. This data is the same as the reflectivity data shown in FIG. 4B. Here, the reflectivity data has some distinct features (i.e., varies sharply) at certain azimuth angles (e.g., approximately at pi/4, 3pi/4, 5pi/4 and 7pi/4). To accommodate these features, the data can be piecewise approximated in well-behaved sections as illustrated in FIG. 7. In this example, low-order functions (e.g., 6^{th} order polynomials for each section) are sufficient for the fits. The fit functions are the smooth curves shown, in FIG. 7, with an arbitrary offset introduced between the experimental data and the fitted data for better visual separation.

Once the parameter values (e.g., coefficients for a polynomial fit) of a model function are computed, the function is then used to compute new interpolated values within the selected sub-volume (step 540). In some embodiments, the number of data points from interpolation is less than the original number of data points in subset of the experimentally acquired data.

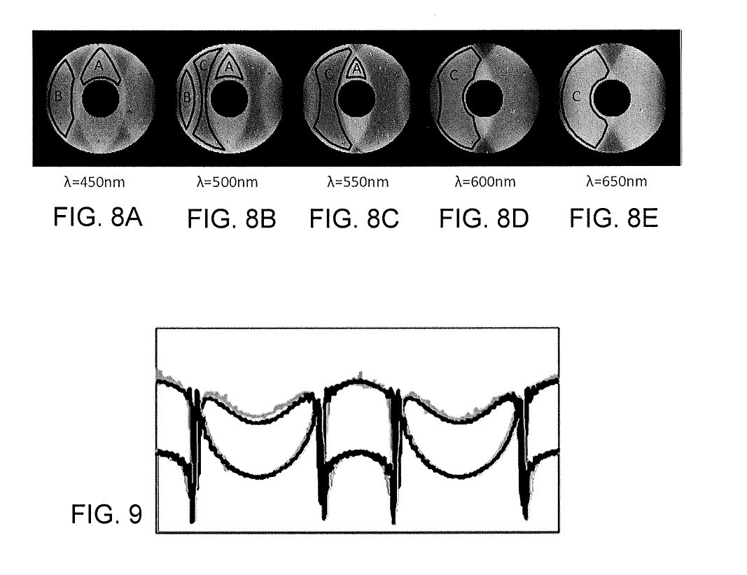

Referring to FIGS. 8A-8E, this general idea is illustrated in plots where sub-volumes with slowly varying reflectivities are defined in a 3-dimensional data space. Specifically, volumes A, B and C are identified in a three-dimensional data space (angle of incidence, azimuth and wavelength) in which rapid changes are not present. These five images show the imaginary part of the reflectivity as seen in a pupil plane of an interferometer (such as described for interferometry system 100 described above) for a 700 nm pitch periodic structure at 450 nm, 500 nm, 550 nm, 600 nm, and 650 nm, respectively.

In some embodiments, a sensitivity analysis based on a model of the nominal sample surface provides derivative information similar to that described previously. Such information can used to choose an optimum set of modeling functions and interpolation volume size. As an example, reflectivity can be a very strong function of the azimuthal position in the case of resolved periodic structures. This is the case, for example, for the data shown in FIG. 9. Here, the real and imaginary part of the reflectivity is shown for a 280-nm pitch grating illuminated under a 50° angle of incidence with 450-nm light. The gray traces are experimental data; the black traces are modeled data.

In this case a sensitivity analysis predicts some regions with sharp and brutal reflectivity transitions and others with slow fluctuations. That information is used to select optimum model functions and interpolating volumes. For instance, the “slow” regions can be easily modeled using low-order polynomials whereas the sharp transitions are better handled using piecewise-linear functions, splines, series of sinusoidal functions, etc.

While the foregoing embodiments involve fitting a function to experimentally acquired data, other approaches are also possible. For example, in some embodiments, a functional data fit is applied to simulated reflectivity data instead of experimentally acquired reflectivity data. For example, in some embodiments, a set of simulated data points is generated for a number of wavelengths, angles of incidence and azimuths based on a model of the structure of the test object. Then, by means of interpolation, data points are generated for all the combinations of wavelengths, angles of incidence and azimuth that exist in the experimental data set. Thus, two complete data sets are available for comparison and all experimental data points can be used.

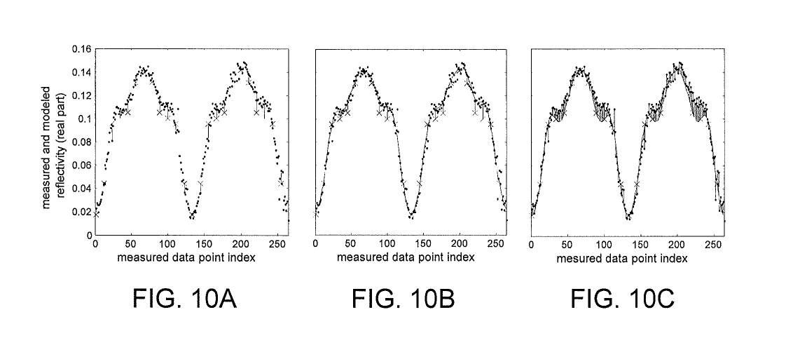

Referring to FIGS. 10A-10C, plots corresponding to various approaches are compared. In these plots, black vertical lines mark the differences between measurement and modeling that are used to drive the experiment (regression or library search). The data in this plots was acquired using a 190 nm pitch shallow trench isolation (“STI”) structure. The data was taken at 45° at 550 nm and entire whole 2π range of azimuth angles.

No interpolation is done for the data shown in FIG. 10A. In other words, the modeled data points are directly compared to the corresponding measured data points. Most of the data points are unused and the measurement noise affects the observed differences (black lines) directly.

In FIG. 10B, a fit function through the experimentally measured data points is found. The modeled data points are then compared to the corresponding value of the fit function.

In FIG. 10C, a functional fit is applied to the limited set of modeled data points. The functional fit can then be evaluated at all illumination parameter combinations for which measured data exist. All measured values are then used for comparison with the modeling. In embodiments, every data point has the same weight, which can help minimize the measurement noise impact (assuming that every data point has the same noise level).

In general, the number of required data points that actually have to be simulated can vary depending on the complexity of the reflectivity function. Slowly varying functions, for example, typically require fewer data points than rapidly varying functions. Complex data surfaces (e.g., including multiple inflection points and/or rapid variations in slope) can require more data points and/or fit functions that are specific to different data space sub-volumes, as illustrated above in FIGS. 7 and 9.

In cases where a sensitivity analysis identifies regions in the available data space that show significantly higher sensitivity than other regions, simulations may be limited to those regions with high sensitivity. Data interpolation then provides high density data in those high sensitivity regions that are subsequently compared with the high density measured data of those regions.

In certain embodiments, the measured and modeled datasets are approximated with the same set of fit functions, leading to two sets of fit coefficients. Regressions or library searches then are driven by the goal to minimize differences not in the data themselves but in its fit coefficients. As in previous embodiments, this approach can be applied to the entire available data volume or to sub-volumes of the reflectivity data space where no rapid changes are expected and/or where the data is expected to have a high sensitivity to structure parameter changes. All measured data points in the chosen volumes are used in the functional fit, which is beneficial in terms of minimizing the measurement noise impact. Furthermore, if the set of fit functions is not perfectly suited to describe the characteristics of the data, it affects the measured data fit in the same way as it affects the modeled data fit, so that the difference between the two sets of fit coefficients still nominally approaches zero. This is true unless the low density modeled data misses some distinct data features.

While a particular interferometry system is shown in FIG. 1, in general, the methods can be implemented using with a wide variety of optical systems that provide reflectivity measurements. Variations of the described interferometric systems can be used. For example, while the light source described for interferometry system 100 is a broadband light source, in general, interferometry systems used for overlay measurements may use monochromatic or broadband light sources. Further, the light source can be a spatially extended light source, e.g., filling the pupil of the objective (e.g., Köhler illumination); but a single source point imaged onto the sample is also feasible and also provides data for an extended range of illumination angles (e.g., for the full pupil).

Furthermore, interferometry systems used for reflectivity measurements can, in embodiments, be used for other types of metrology as well. For example, interferometry system 100 can be used for surface profiling measurements in addition to reflectivity measurements. In some embodiments, interferometry systems can also be adapted for additional functionality by switching between various hardware configurations. For example, the system hardware can be switched between conventional SWLI imaging and pupil plane imaging, allowing, e.g., surface profile measurements to be made alongside reflectivity measurements.

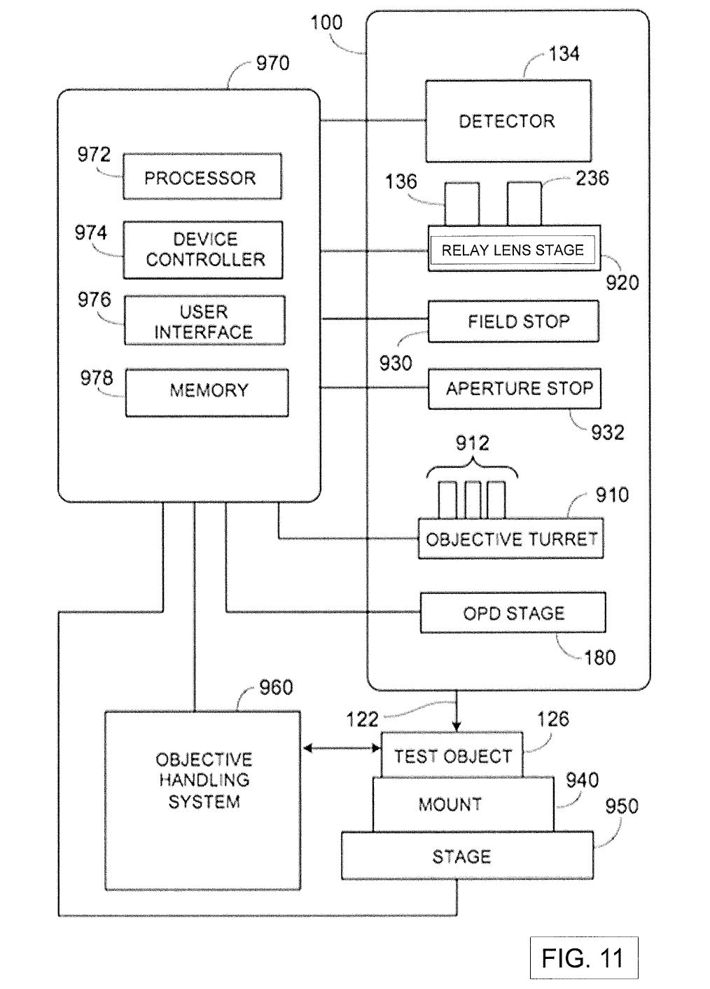

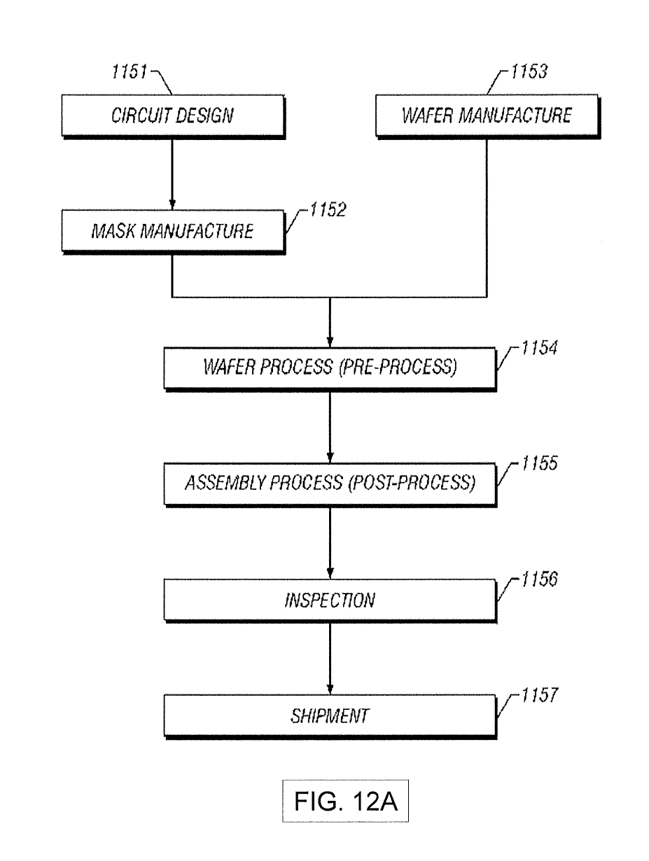

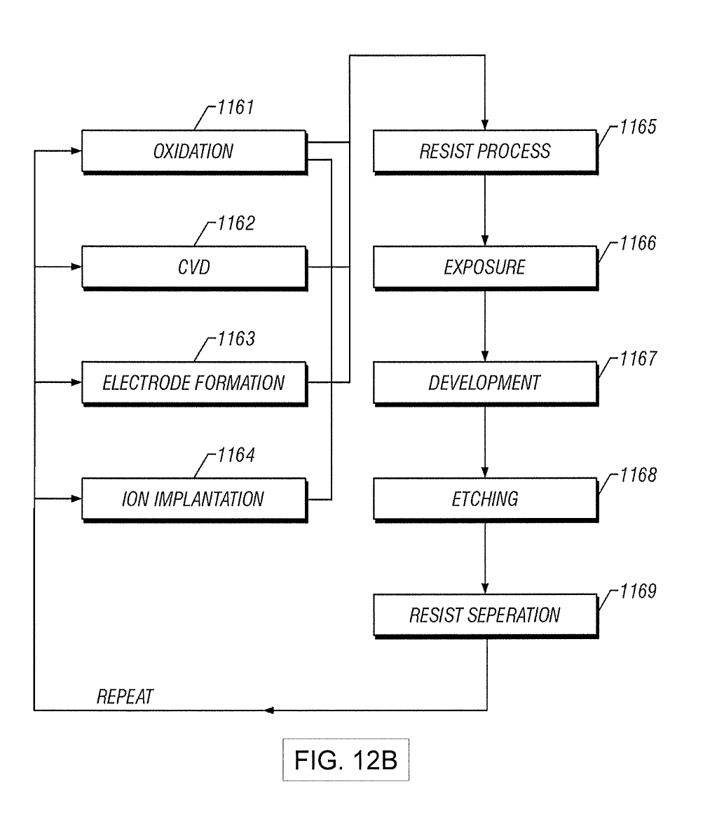

FIG. 11 shows a schematic diagram of how various components in interferometry system 100 can be automated under the control of electronic processor 970, which, in the presently described embodiment, can include an analytical processor 972 for carrying out mathematical analyses, device controllers 974 for controlling various components in the interferometry system, a user interface 976 (e.g., a keyboard and display), and a storage medium 978 for storing calibration information, data files, a sample models, and/or automated protocols.

First, the system can include a motorized turret 910 supporting multiple objectives 912 and configured to introduce a selected objective into the path of input light 104. One or more of the objectives can be interference objectives, with the different interference objectives providing different magnifications. Furthermore, in certain embodiments, one (or more) of the interference objectives can be especially configured for the ellipsometry mode (e.g., pupil plane imaging mode) of operation by having polarization element 146 (e.g., a linear polarizer) attached to it. The remaining interference objectives can be used in the profiling mode and, in certain embodiments, can omit polarization element 146 so as to increase light efficiency (such as for the embodiment described above in which beam splitter 112 is a polarizing beam splitter and polarization element is 142 is a quarter wave plate). Moreover, one or more of the objectives can be a non-interferometric objective (i.e., one without a reference leg), each with a different magnification, so that system 100 can also operate in a conventional microscope mode for collecting optical images of the test surface (in which case the relay lens is set to image of test surface to the detector). Turret 910 is under the control of electronic processor 970, which selects the desired objective according to user input or some automated protocol.

Next, the system includes a motorized stage 920 (e.g., a tube lens holder) for supporting relay lenses 136 and 236 and selectively positioning one of them in the path of combined light 132 for selecting between the first mode (e.g., an ellipsometry or reflectometry mode) in which the pupil plane 114 is imaged to the detector and the second mode (e.g., profiling/overlay or microscope mode) in which the test surface is imaged to the detector. Motorized stage 920 is under the control of electronic processor 970, which selects the desired relay lens according to user input or some automated protocol. In other embodiments, in which a translation stage is moved to adjust the position of the detector to switch between the first and second modes, the translation is under control of electronic processor. Furthermore, in those embodiments with two detection channels, each detector is coupled to the electronic processor 970 for analysis.

Furthermore, the system can include motorized apertures 930 and 932 under control of electronic processor 970 to control the dimensions of field stop 138 and aperture stop 115, respectively. Again the motorized apertures are under the control of electronic processor 970, which selects the desired settings according to user input or some automated protocol.

Also, translation stage 150, which is used to vary the relative optical path length between the test and reference legs of the interferometer, is under the control of electronic processor 970. As described above, the translation stage can be coupled to adjust the position of the interference objective relative to a mount 940 for supporting test object 126. Alternatively, in further embodiments, the translation stage can adjust the position of the interferometry system as a whole relative to the mount, or the translation stage can be coupled to the mount, so it is the mount that moves to vary the optical path length difference.

Furthermore, a lateral translation stage 950, also under the control of electronic processor 970, can be coupled to the mount 940 supporting the test object to translate laterally the region of the test surface under optical inspection. In certain embodiments, translation stage 950 can also orient mount 940 (e.g., provide tip and tilt) so as to align the test surface normal to the optical axis of the interference objective.

Finally, an object handling station 960, also under control of electronic processor 970, can be coupled to mount 940 to provide automated introduction and removal of test samples into system 100 for measurement. For example, automated wafer handling systems known in the art can be used for this purpose. Furthermore, if necessary, system 100 and object handling system can be housed under vacuum or clean room conditions to minimize contamination of the test objects.

The resulting system provides great flexibility for providing various measurement modalities and procedures. For example, the system can first be configured in the microscope mode with one or more selected magnifications to obtain optical images of the test object for various lateral positions of the object. Such images can be analyzed by a user or by electronic processor 970 (using machine vision techniques) to identify certain regions (e.g., specific structures or features, landmarks, fiducial markers, defects, etc.) in the object. Based on such identification, selected regions of the sample can then be studied in the ellipsometry mode to determine sample properties (e.g., refractive index, underlying film thickness(es), material identification, etc.).

Accordingly, the electronic processor causes stage 920 to switch the relay lens to the one configured for the ellipsometry mode and further causes turret 910 to introduce a suitable interference objective into the path of the input light. To improve the accuracy of the ellipsometry measurement, the electronic processor can reduce the size of the field stop via motorized aperture 930 to isolate a small laterally homogenous region of the object. After the ellipsometry characterization is complete, electronic processor 970 can switch the instrument to the profiling mode, selecting an interference objective with a suitable magnification and adjusting the size of field stop accordingly. The profiling/overlay mode captures interference signals that allow reconstructing the topography of, for example, one or more interfaces that constitute the object. Notably, the knowledge of the optical characteristics of the various materials determined in the ellipsometry mode allows for correcting the calculated topography for thin film or dissimilar material effects that would otherwise distort the profile. See, for example, U.S. patent application Ser. No. 10/795,579 entitled “PROFILING COMPLEX SURFACE STRUCTURES USING SCANNING INTERFEROMETRY” and published as U.S. Patent Publication No. US-2004-0189999-A1, the content of which is incorporated herein by reference. If desired, the electronic processor can also adjust the aperture stop diameter via motorized aperture 932 to improve the measurement in any of the various modes.

When used in conjunction with automated object handling system 960, the measurement procedure can be repeated automatically for a series of samples. This could be useful for various process control schemes, such as for monitoring, testing, and/or optimizing one or more semiconductor processing steps.

For example, the system can be used in a semiconductor process for tool specific monitoring or for controlling the process flow itself. In the process monitoring application, single/multi-layer films are grown, deposited, polished, or etched away on unpatterned Si wafers (monitor wafers) by the corresponding process tool and subsequently the thickness and/or optical properties are measured using the interferometry system disclosed herein (for example, by using the ellipsometry mode, the profiling/overlay mode, or both). The average, as well as within wafer uniformity, of thickness (and/or optical properties) of these monitor wafers are used to determine whether the associated process tool is operating with targeted specification or should be retargeted, adjusted, or taken out of production use.

In the process control application, latter single/multi-layer films are grown, deposited, polished, or etched away on patterned Si, production wafers by the corresponding process tool and subsequently the thickness and/or optical properties are measured with the interferometry system disclosed herein (for example, by using the ellipsometry mode, the profiling mode, or both). Production measurements used for process control typical include a small measurement site and the ability to align the measurement tool to the sample region of interest. This site may consists of multi-layer film stack (that may itself be patterned) and thus requires complex mathematical modeling in order to extract the relevant physical parameters. Process control measurements determine the stability of the integrated process flow and determine whether the integrated processing should continue, be retargeted, redirected to other equipment, or shut down entirely.

Specifically, for example, the interferometry system disclosed herein can be used to monitor the following equipment: diffusion, rapid thermal anneal, chemical vapor deposition tools (both low pressure and high pressure), dielectric etch, chemical mechanical polishers, plasma deposition, plasma etch, lithography track, and lithography exposure tools. Additionally, the interferometry system disclosed herein can be used to control the following processes: trench and isolation, transistor formation, as well as interlayer dielectric formation (such as dual damascene).

In some embodiments, light source 102 in system 100 of FIG. 1 is replaced by a tunable monochromatic source under the control of the electronic processor. For example, the source can be a tunable laser diode or a broadband source incorporating a tunable spectral filter to produce a tunable spectral output (e.g., a monochromator, a spectral filter wheel, an acousto-optic tunable filter or a tunable liquid crystal filter.) Furthermore, the position of reference surface 125 (e.g., a reference mirror) is adjusted so that the optical path length difference between the test light and reference light when the test surface is in-focus with respect to the interference objective is non-zero. Detector 134 records the interference pattern produced by the combined light as the wavelength of the source is scanned. There is no mechanical motion of the object with respect to the interferometric objective in this case. Because of the adjustment in the position of the reference mirror and the resulting non-zero optical path length difference between the test and reference legs of the interferometer, the scanning of the source frequency produces an interference signal that is measured at each detector element. This interference signal is sometimes referred to as a “channel spectrum.”

The embodiment shown in FIG. 1 uses an interference objective of the Mirau-type, in which the beam splitter in the interference objective directs the reference light back along the optical axis for the test light. In other embodiments, interferometry system 100 can instead use a different type of interference objective, such as a Michelson objective, in which the beam splitter directs the reference light away from the optical axis of the test light (e.g., the beam splitter can be oriented at 45 degrees to the input light so the test light and reference travel at right angles to one another). In such cases, the reference surface can be positioned outside of the path of the test light.

In some embodiments, the interference objective can be of the Linnik-type, in which case the beam splitter is positioned prior to the objective lens for the test surface (with respect to the input light) and directs the test and reference light along different paths. A separate objective lens is used to focus the reference light to the reference lens. In other words, the beam splitter separates the input light into the test and reference light, and separate objective lenses then focus the test and reference light to respective test and reference surfaces. Ideally the two objective lenses are matched to one another so that the test and reference light have similar aberrations and optical paths.

Additional interferometer configurations are also possible. For example, the system can be configured to collect test light that is transmitted through the test sample and then subsequently combined with reference light. For such embodiments, for example, the system can implement a Mach-Zehnder interferometer with dual microscope objectives on each leg.

The light source in the interferometer may be any of: an incandescent source, such as a halogen bulb or metal halide lamp, with or without spectral bandpass filters; a broadband laser diode; a light-emitting diode; a supercontinuum light source (as mentioned above); a combination of several light sources of the same or different types; an arc lamp; any source in the visible spectral region; any source in the IR spectral region, particularly for viewing rough surfaces & applying phase profiling; and any source in the UV spectral region, particularly for enhanced lateral resolution. For broadband applications, the source preferably has a net spectral bandwidth broader than 5% of the mean wavelength, or more preferably greater than 10%, 20%, 30%, or even 50% of the mean wavelength. For tunable, narrow-band applications, the tuning range is preferably broad (e.g., greater than 50 nm, greater than 100 nm, or greater than even 200 nm, for visible light) to provide reflectivity information over a wide range of wavelengths, whereas the spectral width at any particular setting is preferable narrow, to optimize resolution, for example, as small as 10 nm, 2 nm, or 1 nm. The source may also include one or more diffuser elements to increase the spatial extent of the input light being emitted from the source.

Furthermore, the various translations stages in the system, such as translation stage 150, may be: driven by any of a piezo-electric device, a stepper motor, and a voice coil; implemented opto-mechanically or opto-electronically rather than by pure translation (e.g., by using any of liquid crystals, electro-optic effects, strained fibers, and rotating waveplates) to introduce an optical path length variation; any of a driver with a flexure mount and any driver with a mechanical stage, e.g. roller bearings or air bearings.

The electronic detector can be any type of detector for measuring an optical interference pattern with spatial resolution, such as a multi-element CCD or CMOS detector.

The analysis steps described above can be implemented in computer programs using standard programming techniques. Such programs are designed to execute on programmable computers or specifically designed integrated circuits, each comprising an electronic processor, a data storage system (including memory and/or storage elements), at least one input device, and least one output device, such as a display or printer. The program code is applied to input data (e.g., images from the detector) to perform the functions described herein and generate output information (e.g., overlay error, refractive index information, thickness measurement(s), surface profile(s), etc.), which is applied to one or more output devices. Each such computer program can be implemented in a high-level procedural or object-oriented programming language, or an assembly or machine language. Furthermore, the language can be a compiled, interpreted or intermediate language. Each such computer program can be stored on a computer readable storage medium (e.g., CD ROM or magnetic diskette) that when read by a computer can cause the processor in the computer to perform the analysis and control functions described herein.

Interferometry metrology systems, such as those discussed previously, can be used in the production of integrated circuits to monitor and improve overlay between patterned layers. For example, the interferometry systems and methods can be used in combination with a lithography system and other processing equipment used to produce integrated circuits. In general, a lithography system, also referred to as an exposure system, typically includes an illumination system and a wafer positioning system. The illumination system includes a radiation source for providing radiation such as ultraviolet, visible, x-ray, electron, or ion radiation, and a reticle or mask for imparting the pattern to the radiation, thereby generating the spatially patterned radiation. In addition, for the case of reduction lithography, the illumination system can include a lens assembly for imaging the spatially patterned radiation onto the wafer. The imaged radiation exposes resist coated onto the wafer. The illumination system also includes a mask stage for supporting the mask and a positioning system for adjusting the position of the mask stage relative to the radiation directed through the mask. The wafer positioning system includes a wafer stage for supporting the wafer and a positioning system for adjusting the position of the wafer stage relative to the imaged radiation. Fabrication of integrated circuits can include multiple exposing steps. For a general reference on lithography, see, for example, J. R. Sheats and B. W. Smith, in Microlithography: Science and Technology (Marcel Dekker, Inc., New York, 1998), the contents of which is incorporated herein by reference.

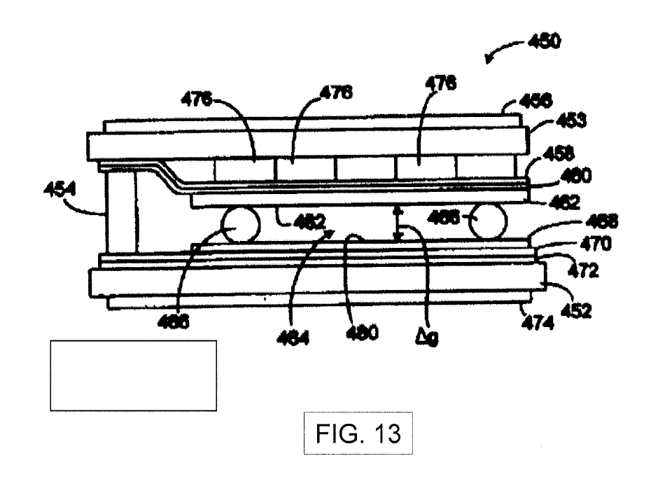

As is well known in the art, lithography is a critical part of manufacturing methods for making semiconducting devices. For example, U.S. Pat. No. 5,483,343 outlines steps for such manufacturing methods. These steps are described below with reference to FIGS. 12A and 12B. FIG. 12A is a flow chart of the sequence of manufacturing a semiconductor device such as a semiconductor chip (e.g., IC or LSI), a liquid crystal panel or a CCD. Step 1151 is a design process for designing the circuit of a semiconductor device. Step 1152 is a process for manufacturing a mask on the basis of the circuit pattern design. Step 1153 is a process for manufacturing a wafer by using a material such as silicon.

Step 1154 is a wafer process which is called a pre-process wherein, by using the so prepared mask and wafer, circuits are formed on the wafer through lithography. To form circuits on the wafer, patterns from multiple masks are sequentially transferred to different layers on the wafer, building up the circuits. Effective circuit production requires accurate overlay between the sequentially formed layers. The interferometry methods and systems described herein can be especially useful to provide accurate overlay and thereby improve the effectiveness of the lithography used in the wafer process.

Step 1155 is an assembling step, which is called a post-process wherein the wafer processed by step 1154 is formed into semiconductor chips. This step includes assembling (dicing and bonding) and packaging (chip sealing). Step 1156 is an inspection step wherein operability check, durability check and so on of the semiconductor devices produced by step 1155 are carried out. With these processes, semiconductor devices are finished and they are shipped (step 1157).

FIG. 12B is a flow chart showing details of the wafer process. Step 1161 is an oxidation process for oxidizing the surface of a wafer. Step 1162 is a CVD process for forming an insulating film on the wafer surface. Step 1163 is an electrode forming process for forming electrodes on the wafer by vapor deposition. Step 1164 is an ion implanting process for implanting ions to the wafer. Step 1165 is a resist process for applying a resist (photosensitive material) to the wafer. Step 1166 is an exposure process for printing, by exposure (i.e., lithography), the circuit pattern of the mask on the wafer through the exposure apparatus described above. Once again, as described above, the use of the interferometry systems and methods described herein can improve the accuracy and resolution of such lithography steps.

Step 1167 is a developing process for developing the exposed wafer. Step 1168 is an etching process for removing portions other than the developed resist image. Step 1169 is a resist separation process for separating the resist material remaining on the wafer after being subjected to the etching process. By repeating these processes, circuit patterns are formed and superimposed on the wafer.

As mentioned previously, the interferometry systems and methods disclosed herein can be used in the manufacture of flat panel displays such as, for example, liquid crystal displays (LCDs).

In general, a variety of different LCD configurations are used in many different applications, such as LCD televisions, desktop computer monitors, notebook computers, cell phones, automobile GPS navigation systems, automobile and aircraft entertainment systems to name a few. While the specific structure of a LCD can vary, many types of LCD utilize a similar panel structure. Referring to FIG. 13, for example, in some embodiments, a LCD panel 450 is composed of several layers including two glass plates 452,453 connected by seals 454. Glass plates 452 and 453 are separated by a gap 464, which is filled with a liquid crystal material. Polarizers 456 and 474 are applied to glass plates 453 and 452, respectively. One of the polarizers operates to polarize light from the display's light source (e.g., a backlight, not shown) and the other polarizer serves as an analyzer, transmitting only that component of the light polarized parallel to the polarizer's transmission axis.

An array of color filters 476 is formed on glass plate 453 and a patterned electrode layer 458 is formed on color filters 476 from a transparent conductor, commonly Indium Tin Oxide (ITO). A passivation layer 460, sometimes called hard coat layer, based on SiOₓ is coated over the electrode layer 458 to electrically insulate the surface. Polyimide 462 is disposed over the passivation layer 460 to align the liquid crystal fluid 464.

Panel 450 also includes a second electrode layer 472 formed on glass plate 452. Another hard coat layer 470 is formed on electrode layer 472 and another polyimide layer 468 is disposed on hard coat layer 470. In active matrix LCDs (“AM LCDs”), one of the electrode layers generally includes an array of thin film transistors (TFTs) (e.g., one or more for each sub-pixel) or other integrated circuit structures.

The liquid crystal material is birefringent and modifies the polarization direction of the light propagating through the material. The liquid crystal material also has a dielectric anisotropy and is therefore sensitive to electric fields applied across gap 464. Accordingly, the liquid crystal molecules change orientation when an electric field is applied, thereby varying the optical properties of the panel. By harnessing the birefringence and dielectric anisotropy of the liquid crystal material, one can control the amount of light transmitted by the panel.

The cell gap Δg, i.e., thickness of the liquid crystal layer 464, is determined by spacers 466, which keep the two glass plates 452, 453 at a fixed distance. In general, spacers can be in the form of preformed cylindrical or spherical particles having a diameter equal to the desired cell gap or can be formed on the substrate using patterning techniques (e.g., conventional photolithography techniques).

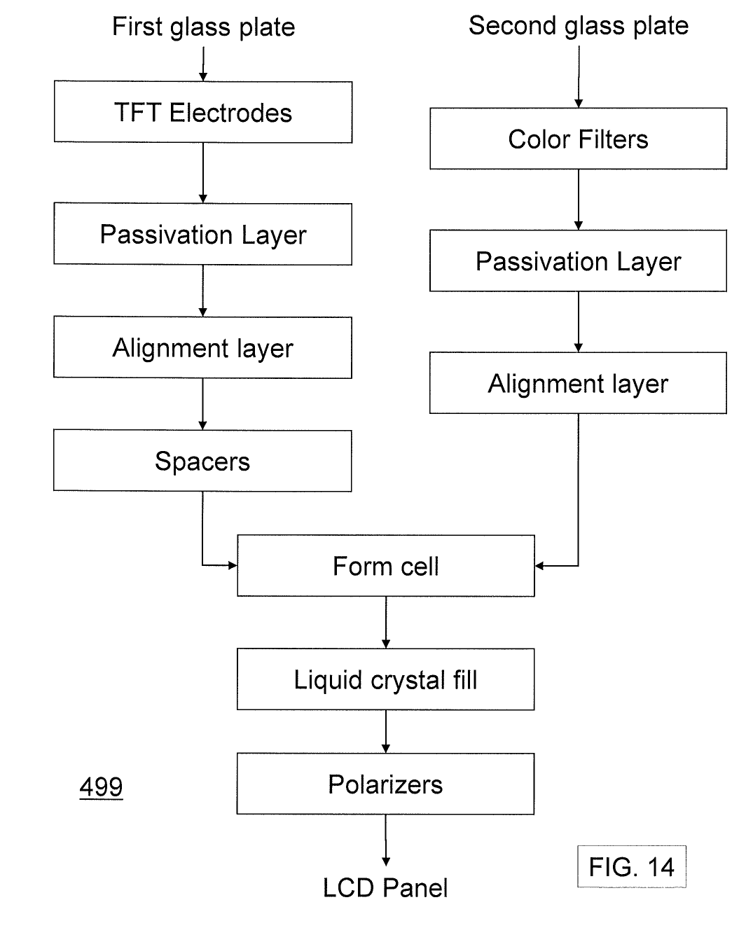

In general, LCD panel manufacturing involves multiple process steps in forming the various layers. For example, referring to FIG. 14, a process 499 includes forming the various layers on each glass plate in parallel, and then bonding the plates to form a cell. The cell is then filled with the liquid crystal material and sealed. After sealing, the polarizers are applied to the outer surface of each of the glass plates, providing the completed LCD panel.

In general, formation of each of the components illustrated in the flow chart in FIG. 14 can include multiple process steps. For example, in the present example, forming the TFT electrodes (commonly referred to as “pixel electrodes”) on the first glass plate involves many different process steps. Similarly, forming the color filters on the second glass plate can involve numerous process steps. Typically, forming pixel electrodes include multiple process steps to form the TFTs, ITO electrodes, and various bus lines to the TFTs. In fact, forming the TFT electrode layer is, in essence, forming a large integrated circuit and involves many of the same deposition and photolithographic patterning processing steps used in conventional integrated circuit manufacturing. For example, various parts of the TFT electrode layer can be built by first depositing a layer of material (e.g., a semiconductor, conductor, or dielectric), forming a layer of photoresist over the layer of material, exposing the photoresist to patterned radiation. The photoresist layer is then developed, which results in a patterned layer of the photoresist. Next, portions of the layer of material lying beneath the patterned photoresist layer are removed in a etching process, thereby transferring the pattern in the photoresist to the layer of material. Finally, the residual photoresist is stripped from the substrate, leaving behind the patterned layer of material. These process steps can be repeated many times to lay down the different components of the TFT electrode layer.

In general, the interferometry techniques disclosed herein can be used to monitor overlay of different components of an LCD panel. For example, during panel production, the interferometry techniques can be used to determine overlay error between patterned resist layers and features beneath the photoresist layer. Where measured overlay error is outside a predetermined process window, the patterned photoresist can be stripped from the substrate and a new patterned photoresist layer formed.

Other embodiments are in the following claims.

What is claimed is:

1. A method, comprising:
fitting a function to a subset of reflectivity data comprising values for the reflectivity of a test object for different wavelengths, different scattering angles, and/or different polarization states;
determining values for the function at certain wavelengths and scattering angles and/or polarization states; and
determining information about the test object based on the determined values.

2. The method of claim 1, wherein the reflectivity data is acquired experimentally.

3. The method of claim 2, wherein the reflectivity data is acquired using an interferometry system.

4. The method of claim 3, wherein the interferometry system acquires the reflectivity data by directing test light to the test object;
subsequently combining the test light with reference light to form an interference pattern on a multi-element detector so that different regions of the detector correspond to different scattering angles of the test light by the test object, wherein the test and reference light are derived from a common source;
monitoring the interference pattern using the multi-element detector while varying an optical path difference between the test light and the reference light; and
determining the reflectivity data based on the monitored interference pattern.

5. The method of claim 1, wherein determining the information comprises comparing the reflectivity data to data derived from a model of the test object.

6. The method of claim 1, further comprising selecting the subset of reflectivity data from acquired data prior to fitting the function.

7. The method of claim 6, wherein the subset is selected based on a derivative of the acquired data with respect to the different wavelengths and/or different scattering angles.

8. The method of claim 6, wherein the subset is selected where the data is well-behaved.

9. The method of claim 1, wherein the function defines a multi-dimensional surface.

10. The method of claim 1, wherein noise in the determined values is reduced relative to noise in the data corresponding to the reflectivity values.

11. The method of claim 1, wherein the reflectivity data comprises values for a real reflectivity and values for an imaginary reflectivity.

12. The method of claim 11, wherein fitting the function comprises fitting a first function to the real reflectivity values and fitting a second function to the imaginary reflectivity values.

13. The method of claim 12, wherein the first and second functions are different.

14. The method of claim 1, wherein fitting the function comprises fitting different functions to different subsets of the data.

15. The method of claim 1, further comprising outputting the information about the test object.

16. The method of claim 1, wherein the information about the test object comprises information about a refractive index of a layer of the test object.

17. The method of claim 1, wherein the information about the test object comprises information about a thickness of a layer of the test object.

18. The method of claim 1, wherein the information about the test object comprises information about a structure on a surface of the test object.

19. A method, comprising:
directing test light to a test object;
subsequently combining the test light with reference light to form an interference pattern on a multi-element detector so that different regions of the detector correspond to different scattering angles of the test light by the test object, wherein the test and reference light are derived from a common source;
monitoring the interference pattern using the multi-element detector while varying an optical path difference between the test light and the reference light;
determining the data based on the monitored interference pattern, the data corresponding to a characteristic of the test object as a function of scattering angles and wavelength and/or polarization states of the test light;
fitting a function to a subset of the data;
determining values for the function at certain wavelengths and scattering angles; and
determining spatial information about the test object based on the determined values.

20. The method of claim 19, wherein the characteristic is a complex reflectivity of the test object.

21. A system comprising:
an interferometer configured to direct test light to a test object and subsequently combine it with reference light, the test and reference light being derived from a common source;
one or more optics configured to direct at least a portion of the combined light to a multi-element detector so that different regions of the detector correspond to different scattering angles of the test light by the test object, the detector being configured to produce interference signals based on the combined light; and
an electronic processor in communication with the multi-element detector,
wherein the electronic processor is arranged to determining reflectivity data comprising values for the reflectivity of the test object for different wavelengths, different scattering angles, and/or different polarization states from the interference signals, fit a function to a subset of the reflectivity data, determines values for the function at certain wavelengths and scattering angles, and determines information about the test object based on the determined values.
